(19) United States
(12) Patent Application Publication
(10) Pub. No.: US 2006/0072228 A1
(43) Pub. Date: Apr. 6, 2006

(54) Method and circuit for operating a storage device

(75) Inventors: Alexander Cornelis Geerlings, Eindhoven (NL); Ozcan Mesut, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., Eindhoven (NL)

(21) Appl. No.: 10/538,626

(22) PCT Filed: Nov. 17, 2003
(86) PCT No.: PCT/IB03/05275

§ 371 Date: Jun. 10, 2005

(30) Foreign Application Priority Data
Dec. 16, 2002 (EP) 02080309.4

(51) Int. Cl. G11B 27/36; G11B 19/02

(52) U.S. Cl. 360/31; 360/69

(57) ABSTRACT

Memory systems like disk drives are usually sensitive to vibrations. In a consumer electronics environment, with reproduction of audio, this is a problem because audio reproduction means generating vibrations. To prevent performance degradation of the memory system, action is taken to reduce the influence of vibrations on the memory system. This is only done when the performance of the storage system drops below a pre-determined level when it causes such a degradation of performance that it is annoying for a user. Of course, the pre-determined level is—among others—influenced by the application that uses the memory system. Actions to be taken may be reducing the sound level, but also advising a user to reduce the sound level or cancel operations that use the storage system.

The invention relates to a method of operating a storage device sensitive to vibrations in an environment with a source of vibrations.

The invention further relates to a circuit for operating a storage device in an environment with a source of vibrations, the circuit comprising a processor.

The invention also relates to a consumer electronics apparatus comprising means for receiving a stream of audio-visual data; a storage device arranged to store the stream of audio-visual data on a disk and a source of vibrations.

Such a method, circuit and apparatus are known from document U.S. Pat. No. 6,067,362. This document discloses an apparatus that reduces the gain of at least certain frequency components of sound produced by a sound system when sound vibrations are expected to hamper the performance parameters of the apparatus. When the level of the output sound or at least of one frequency component of the output sound is too high, the gain of the sound or of that particular frequency component is reduced. The reduction of gain is aimed at preventing a negative influence of vibrations caused by a high sound level on components of the apparatus like a CD-player or a hard disk.

The disclosed circuit always reduces the gain of the sound produced by the apparatus when it exceeds a certain threshold, irrespective of the activity of e.g. the CD-player or the hard disk.

It is an object of the invention to only have the vibrations reduced when these vibrations have a material effect on the performance of the storage device.

This object is achieved by using the method according to the invention, which is characterized in that the method comprises the following steps: monitoring the performance of the storage device; and when the performance of the storage device decreases below a pre-determined level, taking action to reduce the influence of vibrations generated by the source of vibrations.

The performance of the storage device—whether it is a hard disk drive, an optical disk drive or any other kind of storage device—may be measured as the maximum achievable data retrieval or storage rate or the access time. The pre-determined level may be determined by the requirements of the application retrieving data from or storing data in the storage device.

The main advantage of using the method according to the invention is that the influence of the vibrations is only reduced—by e.g. attenuation of sound produced by a sound source—when this is necessary to guarantee a required minimum performance of the storage device. When for example only a bit-rate of 2 Mb per second is required, it is not necessary to take action when the maximum achievable bit-rate of the storage device drops from 35 Mb per second to 5 Mb per second due to vibrations.

In other words: using the method according to the invention ensures that the apparatus applying the method functions according to user preferences as long as possible, i.e. until performance of the apparatus is hampered in a way that a user notices it.

In an embodiment of the method according to the invention, the action comprises the step of providing a message to a user to reduce the vibrations.

Automatic setting of an apparatus, said setting having been set by a user, may be annoying for said user. To prevent annoyance, the user may be provided with a message telling him that he should reduce vibrations, for example reduce the sound level, to ensure proper functioning of the storage device.

In an embodiment of the invention, when the performance decreases below the pre-determined level and the environmental temperature of the storage device is above a further pre-determined level, no action is taken.

The performance of a storage device and especially the performance of a hard disk drive is influenced by the temperature of the storage device. A hot environment may also cause performance degradation of the storage device, below the predetermined level at which the method according to the invention takes action. However, reducing vibrations would have little or no effect on the performance of the hard disk drive. Therefore, no action is taken when the performance of the storage device is reduced to below a pre-determined level and the temperature of the storage device is above a further predetermined level.

In a further embodiment of the invention, the source of vibrations is a loudspeaker, and the loudspeaker and the storage device are comprised in the same housing and the housing is a consumer electronics apparatus; the storage device is arranged to record an incoming stream of audio-visual data; the consumer electronics apparatus is arranged to reproduce the incoming stream of audio-visual data by means of a screen and the loudspeaker; and wherein the method comprises the steps of: storing the incoming stream of audio-visual data on a disk by the storage device, and reproducing the stored stream of audio-visual data stored on the disk by means of a screen and the loudspeaker, and the action to reduce the influence of vibrations generated by the source of vibrations comprises the step of advising a user to display the incoming stream of audio-visual data instead of the stored stream of audio-visual data.

Timeshifting of video data with a time period of for example 5 minutes or even a couple of hours is known. Most implementations use a hard disk, to which data is written simultaneously with the reading of data that has been stored for the time period mentioned, say 5 minutes. Such an implementation may be built in a stand-alone video recorder, but also in a TV-set. Most known TV-sets also have built-in speakers. When the sound volume is so high that sound vibrations interfere with the operation of the hard disk, this may affect the time shift operation—reading and writing of data—in such a way that the quality of the reading and writing process is affected, which is disadvantageous to a user.

One solution could be the reduction of gain, but when a user does not accept this option, it might be an option to switch from time-shifted viewing to live viewing. When the time-shift delay is only small, this will not be a big problem for a user and he can fast forward to live reproduction of the TV-program. In the case of live viewing, the hard disk does not have to be used and when the hard disk is not in operation, operation cannot be hampered by vibrations, which is a clear advantage.

In yet a further embodiment of the invention, the housing is a consumer electronics apparatus arranged to reproduce of audio-visual data; at least one further loudspeaker, not comprised by the consumer electronics apparatus, is connected to the consumer electronics apparatus; and the action comprises the steps of: halting reproduction of the audio-visual data through the loudspeaker comprised by the consumer electronics apparatus; and starting reproduction of the audio-visual data through the further loudspeaker.

Most TV-sets—and other consumer electronics devices—are equipped with connections to connect the TV-set to further speakers or home entertainment systems. This enables a user to connect his TV-set to further and—most often—also better speakers. Usually, such speakers are located away from the TV-set, so vibrations of such speakers are unlikely to influence the performance of the storage device in the TV-set.

Therefore, in the case of vibrations hampering performance of the storage device, vibrations due to sound reproduction by speakers comprised by the TV-set, user inconvenience is reduced to a minimum when switching sound reproduction to remote speakers. This minimized user inconvenience is of course a great advantage of this embodiment.

In again a further embodiment of the invention, the source of vibrations is comprised by a first apparatus and the storage device is comprised by a second apparatus; the first and the second apparatus are connected through a network link; the action is controlling the second apparatus by reducing the power of the vibrations caused by the source of vibrations.

Home networks enable communication between all sorts of electronics devices; for example between a home storage server and a large speaker. When these two devices are located not very far away, about a meter, the vibrations of the large speaker while reproducing audio data, may hamper proper operation of the server. To reduce the influence of the vibrations produced by the speaker on the server, the server can control the gain of the speaker and reduce it.

In another embodiment of the invention, the pre-determined level is replaced by a further lower pre-determined level when the performance of the storage device is below the predetermined level during a pre-determined period.

The performance of the storage device may well be below the threshold at which, according to the invention, action is taken for a longer period of time. In some cases, this might be the case when a user prefers a high sound level, especially of lower frequency components, and takes the performance degradation of the storage device and all its consequences for granted. In that case, action is taken continuously, which may be quite annoying to a user of the consumer electronics apparatus according to the invention.

To prevent this, this embodiment replaces the pre-determined level below which action is taken to reduce the influence of the vibrations by a further lower pre-determined level when the performance of the storage device is below the pre-determined level during a longer period of time.

The circuit according to the invention is characterized in that the processor is conceived to: monitor the performance of the storage device; and when the performance of the storage device decreases below a pre-determined level, take action to reduce the influence of vibrations generated by the source of vibrations.

The consumer electronics apparatus according to the invention comprises the circuit defined in claim 16 for controlling the storage device.

Embodiments of the invention will now be presented by means of Figures, in which:

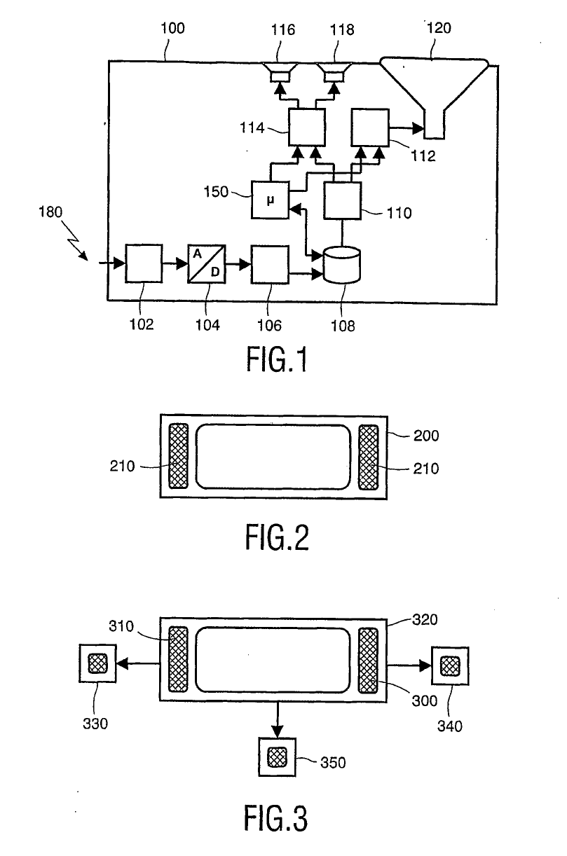

FIG. 1 shows an embodiment of the consumer electronics apparatus comprising an embodiment of the circuit according to the invention;

FIG. 2 shows a TV-set as a further embodiment of the invention;

FIG. 3 shows a TV-set connected to satellite speakers as a further embodiment of the invention;

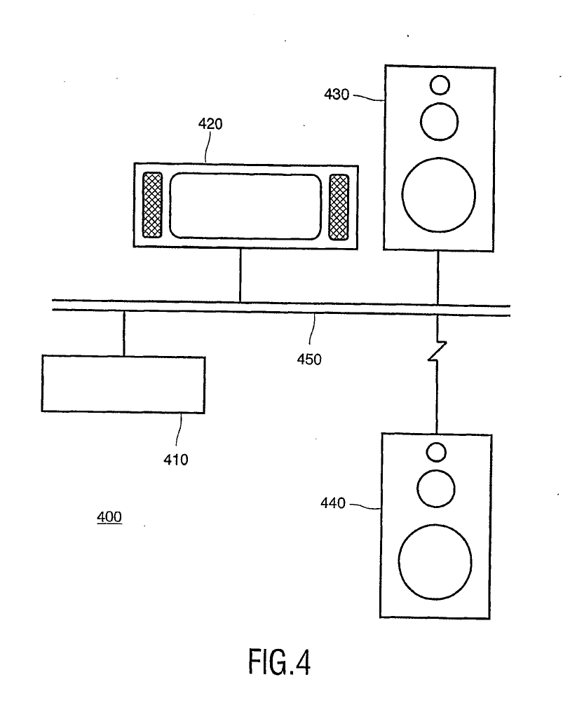

FIG. 4 shows a network environment as an embodiment of the invention; and

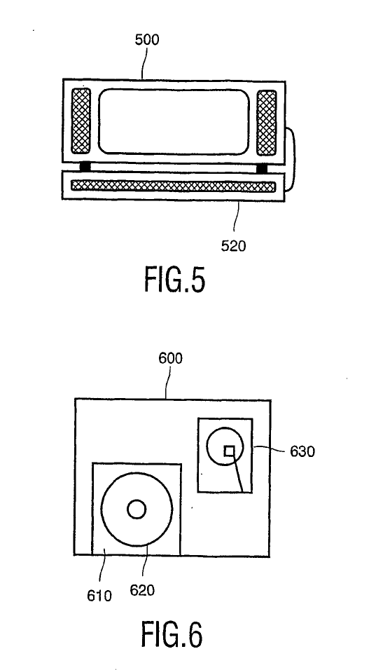

FIG. 5 shows a TV-set connected to a subwoofer unit as another embodiment of the invention.

FIG. 1 shows an apparatus 100 as an embodiment of the consumer electronics device according to the invention. The apparatus 100 comprises a receiver 102 for receiving a signal 180 from a data source like cable, satellite, roof antenna and the like, an analogue to digital converter (A/D converter) 104, a compression unit 106, a storage device 108, a decompression unit 110, a video processor 112, an audio processor 114, a left speaker 116, a right speaker 118, a display unit 120 and a control unit 150.

The receiver 102 is arranged to select and derive a baseband signal from the incoming signal 180. The baseband signal is sent to the A/D converter 104 to convert the baseband signal to a digital stream of audio-visual data. The stream of audio-visual data is transferred to the compression unit 106, which compresses the stream. When the baseband signal is already digital, as in Digital Video Broadcasting (DVB), the A/D converter 104 is obsolete and in some cases, even the compression unit 106 is obsolete, because the incoming signal is already a digital compressed stream of audio-visual data.

The compressed stream of audio-visual data is stored in the storage device 108, which in this embodiment is a hard disk drive. The stored stream can be reproduced by the left speaker 116, the right speaker 118 and the display unit 120. The stream can be reproduced directly upon storage, but also a few minutes later or even hours or days later. In this way, the storage device 108 can be used for a time-shift operation, in which a user is enabled to pause the reproduction of a live television program and continue the reproduction with a delay, by viewing data stored in the storage device 108. During the reproduction, data received is still stored in the storage device 108.

For presentation of the stored stream of audio-visual data, the stream is decompressed by the decompression unit 110. The decompression unit 110 also splits the stream of audio-visual data into an audio part and a video part.

The video part is further processed by the video processor 112 and the audio part is further processed by the audio processor 114. The video processor 112 converts the digital video part to an analogue video part and processes the analogue video signal in such a way that it can be presented by the display unit 120. The display unit 120 may be embodied by a cathode ray tube, a liquid crystal display, a plasma display or any other video display means.

The audio processor 14 converts the digital audio part to an analogue audio part and process the analogue audio signal in such a way that it can be reproduced by the left speaker 116 and the right speaker 118. Although in this embodiment a stereo audio set-up is presented, it will be apparent to a person skilled in the art that any kind of audio set-up is possible, from mono to any imaginable multi-channel sound set-up.

In this embodiment, the speakers are comprised by the apparatus 100. This may be a problem for the storage device, as has been acknowledged by the prior art. Vibrations generated by the speakers disturb the functionality of the storage device 108. Examples of this are numerous, especially in the case of a disk-based memory like a Digital Versatile Disc or a hard disk drive. Vibrations propagating into the actuator or disk assembly are viewed as external disturbances, which makes it more difficult for the pick-up unit to follow a track on the disk

Besides, the vibrations affect the pick up unit itself Vibration cause bad reading of data leading to degradation of the performance of the memory and in the worst case, even crash of the pick-up unit in the disk, which is disastrous for the lifetime and performance aspects of the storage device. Such effects are often obscured for a while to the integral apparatus 100 by error handling procedures in the apparatus 100. Only a performance monitoring tool may detect the onset of these changes.

Prior-art systems try to kill the vibrations but do it in a rigid way, even when this is not necessary. For example, when the storage device is not in use and the pick-up unit is in a safe position, vibrations cannot degrade the performance of the storage device. Therefore, the vibrations do not have to be killed. Furthermore, when only little performance is needed, say 20% of the nominal performance, and vibrations bring down performance to a level of 50% of the nominal performance, the vibrations do not have to be killed either.

This is an important basic principle. Especially when the vibrations are caused by a sound source, it is not desirable to unnecessarily modify the sound volume because this is annoying for a user. Using the method according to the invention, action is only taken to reduce the vibrations when the vibrations cause unacceptable degradation of the performance of the storage device; when the performance drops below a pre-determined level. Of course, the setting of the pre-determined level may depend on the application that uses the storage device.

The performance may be measured in various ways. In the embodiment of the invention described by means of FIG. 1, the control unit 150 keeps statistics on the access time of the storage device 108. When the average access time is too long for a certain amount of time, say over 500 milliseconds for a period of 10 seconds, action is taken. Of course, various related embodiments are obvious to those skilled in the art, such as taking action when the median access time is too high, the maximum access time is too high or the standard deviation of the access time is too high.

In a further embodiment of the invention, action is taken when the average bit-rate of data flowing from the storage device 108 to the decompression unit 110 drops below a predetermined level. Again, various variations are obvious to a person skilled in the art.

As mentioned in a previous paragraph, the pre-determined level may depend on the application that uses the storage device. When the application is the reproduction of a stream of audio-visual data that is stored on the storage device, this application may require a certain bit-rate for proper operation, say 4 Megabits per second. When the storage device is used by this application only, the performance of the storage device may be determined by the bit-rate and the pre-determined limit is 4 Megabits per second, preferably with a safety margin of 10%.

Actions that can be taken to reduce the level of the vibrations are numerous and depend on the set-up of an apparatus using the method according to the invention or an embodiment thereof. Embodiments described here are mainly related to audio vibrations. However, the invention may be used as well to reduce the influence of other vibrations on a storage system.

First, the apparatus can take action itself to kill the vibrations. Various embodiments of the method according the invention doing this will be discussed hereinafter. In another embodiment of the method according to the invention, the apparatus takes action to reduce the influence of the vibrations by providing a message to a user of the apparatus. The message advises a user to reduce vibrations. When this embodiment of the method according to the invention is used for example in a digital television set where the vibrations are most likely to be caused by sound produced by built-in speakers, a user may be supplied with an on-screen message to turn down the volume produced by the television set.

In a further embodiment, when a television set equipped with a recording device records a television program for time shift purposes, a user is advised to watch the recorded program in a live mode, rather than with a delay. In this way, the program does not have to be recorded and the recording process is not influenced by any vibrations, because there is no recording process.

In yet a further embodiment of the invention, general ‘household’ activities of the hard disk, like background defragmentation, are halted when the performance of the hard disk drive degrades because of e.g. vibrations. In this way, the normal recording and/or playback process can be continued without problems. The ‘household’ activities are continued when the performance of the hard disk drive is up again.

As mentioned previously, the apparatus can take also action itself to reduce the influence of vibrations. In one embodiment according to the invention, the amount of vibrations is reduced. When this embodiment of the method according to the invention is used in a TV-set 200 (FIG. 2) comprising speakers 210 (FIG. 2) which produce vibrations (sound) disturbing the performance of a storage device built in the TV-set, the volume of the sound produced by the speakers is reduced. In yet another embodiment, only the levels of certain parts of the frequency spectrum causing vibrations are killed. Examples may be found in U.S. Pat. No. 6,067,362.

However, it might be possible that a user prefers a loud sound to go with a program presented by a TV-set and still wants to record a program. In this case, the problem may be solved by shutting down speakers comprised by the TV-set and provide sound via other speakers. This is depicted in FIG. 3, which shows a TV-set 300 with a built-in left speaker 310, a built-in right speaker 320 and connected to a left satellite speaker 330, a right satellite speaker 340 and a back satellite speaker 350. The TV-set 300 comprises a storage device (not shown).

When the performance of the storage device drops below a level which is not acceptable for the task it is performing at that time, the sound of the built-in left speaker 310 and the built-in right speaker 320 is cut off and re-directed to the left satellite speaker 330, the right satellite speaker 340, respectively, and—optionally—the back satellite speaker 350.

The remote speakers may already have been switched on when sound to the built-in speakers is switched off. In one embodiment of the method according to the invention, no sound is redirected from the built-in speakers to the remote speakers. In a further embodiment, the sound of the built-in speakers is re-directed and added to the sound already produced by the remote speakers.

When the satellite speakers are located far away enough, the sound vibrations they produce will no longer influence the storage device built in the TV-set 300. When the sound level produced by the TV-set is reduced to a level at which no degradation of the performance of the storage device was detected, the built-in left speaker 310 and the built-in right speaker 320 may be switched on again.

Alternatively, this is done when the performance of the storage device increases to a level above a further pre-determined limit that may be equal to the pre-determined level at which the sound of the built-in left speaker 310 and the built-in right speaker 320 is cut off.

Another embodiment of the method according to the invention will be described with reference to FIG. 4, which shows a network environment 400, comprising a server 410, a TV-set 420, a first speaker 430 located close to the TV-set 420 comprising a storage device (not shown), a second speaker 440 located away from the TV-set 420 and a wired or wireless network 450 connecting all devices. The devices may communicate over the network directly to each other or via the server 410, using any kind of protocol from Aloha to USB and TCP/IP and many more without departing from the scope of the invention.

In normal operation of the TV-set 420 when reproducing audio-visual data stored on the storage device, audio data is reproduced by the first speaker 430. When the performance of the storage device drops below a pre-determined level, this is signaled to the server 410, which will lower the sound produced by the first speaker 430.

The reduction of the sound volume may be compensated by reproducing the audio-data by the second speaker 440 as well. Since the second speaker 440 is located away from the TV-set, influence of the sound vibrations produced by the second speaker 440 on the performance of the storage device will be much less. In a further embodiment of the invention, the storage device is located in the server 410, which may be located in the vicinity of a speaker or other source of vibrations as well.

Vibrations may be airborne like sound waves traveling through the air, but also traveling in structures and traveling from one structure to an adjacent structure. FIG. 5 shows a TV-set 500 comprising a storage device (not shown), with a sub-woofer unit 520 connected thereto. The sub-woofer unit 520 is a speaker designed to augment low frequency components of an audio signal, preferably generated by the TV-set 500.

While producing low-frequency audio signals, not only the speaker membrane (not shown) of the sub-woofer unit 520 will vibrate, but also the full outer structure of the sub-woofer unit 520. These vibrations will be transferred to the TV-set 500, influencing the performance of the storage device. According to a preferred embodiment, when the level of vibrations is too high so that normal operation of the storage device is not possible, the sub-woofer is turned off by a controller (not shown) in the TV-set 500. In a further embodiment of the invention, the sound produced by the subwoofer is attenuated when vibrations hamper proper performance of the storage device.

Airborne or structure-borne vibrations may also be amplified by the environment in which the TV-set 500 is placed. In that case, the method according to the invention will take action at a lower sound volume.

FIG. 6 shows a consumer electronics recording device 600 for recording audio-visual data. The recording device 600 comprises an optical disk drive 610 for reading data from and writing audio-visual data to an optical disk 620 and further comprises a hard disk drive 630 for storage and retrieval of audio-visual data.

When reading or writing data at high speeds—higher than real-time—, the optical disk 620 is rotated at high speeds, generating aerodynamic noise. This is a very wide spectrum noise having a significant energy level, causing the structure of the recording device 600 to vibrate. Since the hard disk drive 630 is built in the structure of the recording device 600, vibration will be transferred to the hard disk drive 630, hampering the performance of the hard disk drive 630.

The influence of the vibration in the structure on the hard disk drive 630 may be reduced by various means of suspension, but since consumer electronics devices should not be too large and not too heavy, this is not always a proper solution. Furthermore, suspension does not solve the problem of airborne vibrations caused by the optical disk drive 610 and isolation to solve this problem consumes valuable space and creates cooling problems.

According to an embodiment of the method according to the invention, the recording device takes action to reduce the influence of the vibrations caused by the optical disk drive 610 on the performance of the hard disk drive 630. In one embodiment, the rotation speed of the optical disk 630 is reduced. In a further embodiment, a user is warned that the high rotation speed of the optical disk is hampering the performance of the hard disk drive 630 and the user is either advised to reduce the rotational speed of the optical disk or cancel activities that involve action of the hard disk drive 630.

The performance of the storage device may well be below the threshold at which, according to the invention, action is taken for a longer period of time. For certain embodiments, this might be the case when a user prefers a high sound level, especially of lower frequency components, and takes the performance degradation of the storage device and all its consequences for granted. In that case, action is taken continuously, which may be quite annoying to a user of the consumer electronics apparatus according to the invention.

To prevent this, an embodiment of the method according to the invention replaces the pre-determined level below which action is taken to reduce the influence of the vibrations by a further lower pre-determined level when the performance of the storage device is below the pre-determined level during a longer period of time.

Also, the performance of a storage device and especially the performance of a hard disk drive is influenced by the temperature of the storage device. A hot environment may also cause performance degradation below the pre-determined level at which the method according to the invention takes action. However, reducing vibrations would have little or no effect on the performance of the hard disk drive. Therefore, according to an embodiment of the invention, no action is taken when the performance of the storage device reduces below a pre-determined level and the temperature of the storage device is above a flier pre-determined level.

To this end, the storage device may be equipped with a temperature sensor. Some hard disk drives are already equipped with a temperature sensor; this sensor may be used when employing this embodiment of the method according to the invention.

It will be apparent to any person skilled in the art from the description of the preferred embodiment that the source of vibrations is not limited to sound sources or spinning disks, but extends beyond that. The invention may also be employed in cars, which are known to be an environment with lots of vibrations.

It will also be apparent that the storage device is not limited to a hard disk drive or an optical disk drive, but may be used in any environment using a storage device susceptible to vibrations.

Furthermore, it will be understood as well that the action taken by the method according to the invention when the performance of the storage device drops below a pre-determined level may be embodied in numerous ways; direct as well as via a user of a device employing the method according to the invention.

The invention may be summarized as follows:

Memory systems like disk drives are usually sensitive to vibrations. In a consumer electronics environment, with reproduction of audio, this is a problem because audio reproduction means generating vibrations. To prevent performance degradation of the memory system, action is taken to reduce the influence of vibrations on the memory system. This is only done when the performance of the storage system drops below a pre-determined level when it causes such a degradation of performance that it is annoying for a user. Of course, the pre-determined level is—among others—influenced by the application that uses the memory system. Actions to be taken may be reducing the sound level, but also advising a user to reduce the sound level or cancel operations that use the storage system.

1. A method of operating a storage device sensitive to vibrations in an environment with a source of vibrations, characterized in that the method comprises the following steps:
(a) monitoring the performance of the storage device, and
(b) when the performance of the storage device decreases below a pre-determined level, taking action to reduce the influence of vibrations generated by the source of vibrations.

2. A method as claimed in claim 1, wherein the performance of the storage device is indicated by service time statistics of the storage device.

3. A method as claimed in claim 1, wherein the performance of the storage device is indicated by the average bit-rate of the storage device.

4. A method as claimed in claim 1, wherein the action comprises the step of providing a message to a user to reduce the vibrations.

5. A method as claimed in claim 1, wherein the source of vibrations is at least one loudspeaker, and the loudspeaker and the storage device comprised in the same housing.

6. A method as claimed in claim 1, wherein the source of vibrations is a loudspeaker and the action is reduction of the volume of the sound produced by the loudspeaker.

7. A method as claimed in claim 1, wherein when the performance decreases below the pre-determined level and the environmental temperature of the storage device is above a further pre-determined level, no action is taken.

8. A method as claimed in claim 5, wherein
(a) the housing is a consumer electronics apparatus;
(b) the storage device is arranged to record an incoming stream of audio-visual data;
(c) the consumer electronics apparatus is arranged to reproduce the incoming stream of audio-visual data by means of a screen and the loudspeaker; and
wherein the method comprises the steps of:
(d) storing the incoming stream of audio-visual data on a disk by the storage device; and
(e) reproducing the stored stream of audio-visual data stored on the disk by means of a screen and the loudspeaker.

9. A method as claimed in claim 8, wherein the action to reduce the influence of vibrations generated by the source of vibrations comprises the step of advising a user to display the incoming stream of audio-visual data instead of the stored stream of audio-visual data.

10. A method as claimed in claim 5, wherein
(a) the housing is a consumer electronics apparatus arranged to reproduce audio-visual data;
(b) at least one further loudspeaker, not comprised by the consumer electronics apparatus, is connected to the consumer electronics apparatus; and
(c) the action comprises the steps of:
i.) halting reproduction of the audio-visual data through the loudspeaker comprised by the consumer electronics apparatus; and
ii.) starting reproduction of the audio-visual data through the further loudspeaker.

11. A method as claimed in claim 1, wherein the source of vibrations is comprised by a first apparatus and the storage device is comprised by a second apparatus; the first and the second apparatus are connected through a network link; and the action is controlling the second apparatus by reducing the power of the vibrations caused by the source of vibrations.

12. A method as claimed in claim 1, wherein the pre-determined level is replaced by a further lower pre-determined level when the performance of the storage device is below the predetermined level during a pre-determined period.

13. A method as claimed in claim 1, wherein the vibrations are vibrations in a structure comprising the storage device.

14. A method as claimed in claim 1, wherein the vibrations are airborne vibrations.

15. A method as claimed in claim 1, wherein the storage device is a disk drive.

16. A method as claimed in claim 1, wherein the action is halting activities related to the storage device other than storage and retrieval of audio-visual data.

17. Circuit for operating a storage device in an environment with a source of vibrations, the circuit comprising a processor, characterized in that the processor is conceived to:
(a) monitor the performance of the storage device; and
(b) when the performance of the storage device decreases below a predetermined level, take action to reduce the influence of vibrations generated by the source of vibrations.

18. Consumer electronics apparatus comprising:
(a) means for receiving a stream of audio-visual data;
(b) a storage device arranged to store the stream of audio-visual data on a disk;
(c) a source of vibrations;
(d) the circuit according to claim 17 for controlling the storage device.

19. Consumer electronics apparatus as claimed in claim 18, wherein the source of vibrations is a disk drive arranged to spin a disk in operation.

20. Consumer electronics apparatus as claimed in claim 17, wherein the source of vibrations is a loudspeaker.
